(19) United States
(12) Patent Application Publication
(10) Pub. No.: US 2007/0150428 A1
(43) Pub. Date: Jun. 28, 2007

(54) INFERENCE ENGINE FOR DISCOVERING FEATURES AND MAKING PREDICTIONS USING GENERALIZED INCREMENTAL SINGULAR VALUE DECOMPOSITION

(76) Inventor: Brandyn Webb, Incline Village, NV (US)

Correspondence Address: Brandyn Webb, c/o Vincent DiCarlo, 1561 Pinnacles Place, Davis, CA, 95616-6660, US

(21) Appl. No.: 11/688,800

(22) Filed: Mar. 20, 2007

(51) Int. Cl. G06N 5/02

(52) U.S. Cl. 706/46

(57) ABSTRACT

Method of automated inference using generalized incremental singular value decomposition by following the gradient of a cost function incorporating an error function of the implicit matrix defined by a current estimate of a partial SVD and the observed values. Accommodates sparse or overfilled matrices and correction for nonlinearities. Any number of observed values can be supplemented or updated, and predictions made at at any time. Any number of features can be used. Useful wherever there are two classes of objects (or the same class twice) for which there is a particular value implicitly associated with each pairing of such objects, for example including preference, filtering, rating, and recommender systems, image and other data recognition, compression, and restoration systems, warning systems, autonomous navigation, expert systems, machine learning, language processing, semantic analysis, artificial intelligence, knowledge systems, behavior prediction, economic and financial modeling, and modeling of natural systems.

### CROSS-REFERENCE TO RELATED APPLICATIONS

Not Applicable

### FEDERALLY SPONSORED RESEARCH

Not Applicable

### COMPUTER PROGRAM LISTING

Not Applicable

### BACKGROUND OF INVENTION

1. Field of Invention

My inference engine relates to data processing systems and methods for automated inference, specifically to systems and methods that discover meaningful features in sets of data and that are able to use those features to predict missing data belonging to a set when some data in that set are known.

2. Prior Art

One way of looking at intelligent inference is that it is the capacity to generalize from given data, and then to use those generalizations (or features) successfully to predict other data of interest. For example, collaborative filtering or recommender systems use data about the stated preferences or the behavior of a user to determine what movies, websites, books, songs, videos, other products or services, advertisements, offers, or other things the user will like or dislike, buy or not buy, or respond to in some other way. Many image compression, other data compression, and image restoration systems restore missing or removed data by generalizing from the known or remaining data and then using using those generalizations to predict the values of the data that are missing or removed. Recognition systems use visual or other information about a physical object or set of data to generalize and then predict data concerning standard views or other characteristics of the object or data. Warning systems use data to generalize and predict when hazardous or other conditions of interest exist.

Examples like this could be multiplied at great length. Therefore, the uses of an invention that enables a computer, in a wide variety of contexts, to discover generalizations (or features) from given data and then to predict other related data of interest based on those generalizations are broad and significant. That is what my inference engine does.

My invention is related to others that associate a quantitative value with each selected property of an instance of a phenomenon of a given class, then consider each such quantitative value as an orthogonal dimension in a vector space so that each instance of the phenomenon becomes associated with a point in the vector space, thereby permitting matrix methods to be used to analyze the relationships between the instances and properties, and to predict the quantitative values associated with unknown properties, where one or more of those quantitative values are known. Different matrix techniques have been used this way. For example, U.S. Pat. No. 6,888,955 to Masumoto (1985) uses eigen decomposition to recognize objects in pictures.

However, eigen decomposition is only applicable to symmetrical data, which limits its utility. My inference engine, in the simplest case, performs singular value decomposition, of which eigen decomposition is a special case, and which has been incorporated into previous systems for artificial intelligence. For example, U.S. Pat. No. 4,839,853 to Deerwester et al. (1989) discloses a method for responding to document search queries by constructing a matrix from data relating to the documents and performing singular value decompositions of that matrix.

Previous methods of predicting missing data by using singular value decomposition were limited by, among other things, the need to create a representation of the entire data matrix to be decomposed, the fact that the time and resources required for decomposition increase rapidly with the size of the data matrix, difficulties in applying them to sparse matrices, difficulties in applying them to matrices in which data is overrepresented, difficulties in updating the decompositions when new data is added, and difficulties in correcting for nonlinearities in the data. Previous attempts to remedy these problems have involved methods that,
(a) even if run to completion, and even if run without corrections for nonlinearities, only approximate the results of a singular value decomposition of the whole data matrix, for example, U.S. Pat. No. 7,124,081 to Bellegarda (2006), or
(b) do not produce useful results within a short time after the processing of the known data begins, for example U.S. Pat. No. 4,839,853 to Deerwester et al. (1989), or
(c) do not automatically discover the most useful decompositions, for example Jieping Ye, Generalized Low Rank Approximations of Matrices, Machine Learning, 61:167-191, or
(d) produce models that are not easily updated one data point at at time, for example U.S. patent applications 20030200097 and 20040158497 by Brand, which update by row or column rather than by cell, or
(e) involve partitioning of the data, for example U.S. Pat. No. 7,152,065 to Behrens, et al. (2006), or
(f) are complicated to implement, for example U.S. Pat. No. 6,122,628 to Castelli et al. (2000), or
(g) do not provide convenient integrated means to modify the singular value decomposition to enable nonlinear modeling of the data, for example U.S. patent application 20030200097 by Brand, or
(h) do not provide convenient means to analyze multiple values contributing to the value in a single cell of the data matrix to be decomposed, or
(i) are limited in application to narrow domains, for example U.S. Pat. No. 6,888,955 to Masumoto (1985), which is limited to picture recognition.

My inference engine comprises a simple, efficient, general, iterative, and fully incremental method of discovering patterns or features in the order of their usefulness by performing a generalized analogue of singular value decompositions of large implicit or explicit data matrices, without first having to create the whole data matrix being decomposed; of correcting the decompositions for nonlinearities; and of using the resulting decompositions to make useful predictions in a wide variety of contexts.

3. Objects and Advantages

Several objects and advantages will become apparent from a consideration of the detailed description below. Such objects include, for example,
(a) filtering or recommender systems that use data about the stated preferences or the behavior of a user to determine what movies, websites, books, songs, videos, other products or services, advertisements, offers, or other things the user will like or dislike, buy or not buy, or respond to in some other way,
(b) image compression, other data compression, and image restoration or other data restoration systems that restore missing or removed data by generalizing from the known or remaining data and then using using those generalizations to predict the values of the data that are missing or removed,
(c) recognition systems that use visual or other information about a physical object or set of data to generalize and then predict data concerning standard views or other characteristics of the object or data,
(d) warning systems that use data to generalize and predict when hazardous or other conditions of interest exist,
(e) language recognition and processing,
(f) autonomous navigation,
(g) expert systems,
(h) machine learning,
(i) artificial intelligence,
(j) behavior prediction,
(k) economic and financial modeling,
(l) modeling of natural systems,
(m) discovering meaningful features relating to any category of phenomena wherever there are two classes of objects (or the same class twice) for which there is a particular value implicitly associated with each pairing of such objects,
(n) using features that it discovers to predict missing data belonging to a set when some data in that set is known,
(o) obtaining predictions of data for the purpose of blending or combining that data with data obtained by other methods.

For example and without limitation, my inference engine's advantages include that it
(a) uses a simple incremental method that, when run unmodified for nonlinearities, converges on the result of a singular value decomposition of the entire data matrix,
(b) automatically discovers and exploits features in the training data in order of importance,
(c) quickly produces useful predictions using large sets of data that would otherwise require the decomposition of large matrices,
(d) provides useful predictions in a short time and incrementally more accurate predictions thereafter,
(e) does not require the construction of the entire data matrix to be decomposed before producing useful results,
(f) does not require the partitioning of the training data,
(g) can easily update its data model one data point at a time,
(h) requires less computer memory than prior art,
(i) can be run until an approximation to complete decomposition is optimal for the particular application involved,
(j) overcomes some of the difficulties encountered by other methods that attempt to use singular value decompositions to analyze sparse matrices,
(k) is easy to implement,
(l) provides convenient integrated means to modify the singular value decomposition to enable nonlinear modeling of the data,
(m) provides convenient means to analyze multiple values contributing to the value in a single cell of the data matrix to be decomposed,
(n) provides convenient means to distribute the processing it requires by, for example, using different computers, processors, or threads to process different features or subsets of the data, and
(o) is useful across a wide domain of applications because it can discover useful features and make useful predictions concerning any class of phenomena where there are two classes of objects (or the same class twice) for which there is a particular value implicitly associated with each pairing of such objects.
   Still further objects and advantages will become apparent from a consideration of the ensuing description.

### SUMMARY

My inference engine comprises a method of incrementally approximating a partial or complete singular value decomposition, or non-linear generalization thereof, of a fully, partially, and/or overly observed, actual or implicit data matrix by iteratively following the gradient of a cost function incorporating any pertinent error function that compares the implicit matrix defined by the current estimate of the singular value decomposition with the observed values from the implicit data matrix. The incremental method allows the accommodation of sparse or overfilled matrices, and correction for nonlinearities. The observed values used may be drawn from a finite or unlimited pool (such as, for example, a live video camera or a stream of responses from users), or may be the remaining discrepancy from such values after some initial prediction or estimation is made using my invention or another method, and may be updated by as little as one observed or predicted value at at time. Features can be defined and specified values, from a single value to the entire implicit data matrix, predicted at any stage of the processing.

While the preferred embodiment described below predicts unknown movie ratings from a set of known ratings, my invention has a broad range of applications and embodiments in any setting where there are two classes of objects (or the same class twice) for which there is a particular value implicitly associated with each pairing of such objects, including but not limited to preference, filtering, or recommender systems, image and other data recognition, compression, and restoration, warning systems, autonomous navigation, expert systems, machine learning, artificial intelligence, behavior prediction, economic and financial modeling, and modeling of natural systems.

### DRAWINGS

Not Applicable

### DETAILED DESCRIPTION OF THE PREFERRED EMBODIMENT

The nature of the invention is such that it can make useful predictions concerning any category of phenomena where there are two classes of objects (or the same class twice) for which there is a particular value implicitly associated with each pairing of such objects. Therefore, the preferred embodiment given is only one of many such embodiments that are contemplated.

Generalized Incremental Singular Value Decomposition

As will become apparent, my invention incorporates a method that, under certain circumstances, will produce a result that is mathematically equivalent to performing a completed singular value decomposition upon a data matrix. However, simply constructing and decomposing a data matrix using the usual methods carries with it a number of disadvantages, some of which are described above. Moreover, even using my incremental method, since a complete singular value decomposition perfectly reconstructs the original data matrix, it is not helpful for predicting unknown values in that matrix. Moreover, singular value decomposition, by itself, does not provide a method for handling situations in which zero or more than one value is available as an input for a position in the data matrix. In other words, it does not by itself solve problems associated with sparse data or overfilling. Finally, standard singular value decomposition is only helpful to the extent that the relationship between features in the data are linear, and many phenomena include nonlinearities.

To overcome some of limitations of standard singular value decomposition, my invention incrementalizes and generalizes it so that
(a) it accommodates sparse and overfilled explicit or implicit data matrices,
(b) it can include one or more non-linear functions, such as clipping and curve fitting,
(c) it can be halted at any stage desired to obtain the optimal result for a particular embodiment or application,
(d) it incorporates the data one item or cell at a time without requiring the data to be explicitly represented in matrix form and without requiring that more than one data item be available at a time, which is why I sometimes speak of decomposing an implicit data matrix, and
(e) it can be used to predict missing values for selected positions in the implicit data matrix.
   This is why my inference engine is said to use a “generalized” method of incremental singular singular value decomposition. When the parameters that modify the results to account for nonlinearities are omitted or set to values that cause them to have no effect on the outcome, the data exactly fill the implicit data matrix, and the method is run to convergence, the result is mathematically equivalent to performing a standard singular value decomposition of the implicit data matrix. However, the method comprised by my invention also accommodates other cases.
   The Problem Solved by the Preferred Embodiment

The preferred embodiment described here produces a set of predictions of unknown ratings given by customers to movies that was further processed and entered in the Netflix Prize competition (www.netflixprize.com) under the team name “simonfunk”. Netflix, Inc. provided approximately 100 million ratings (integer values from 1 to 5) of approximately 17 thousand movies by approximately 500 thousand users. Each of the 100 million known ratings was given in the form of a triplet of numbers: (User, Movie, Rating). For example, one such entry might be (105932,14002,3). Netflix then asked participants to predict about 2.8 million ratings that it didn't provide. In particular, for each of about 2.8 million triplets of (User, Movie,?), where participants are given User and Movie but not the Rating, Netflix asked participants to predict the actual rating, which it, but not the participants, knew.

For visualizing the problem, it makes sense to think of the data as a big sparsely filled matrix, with users across the top and movies down the side, and where each cell in the matrix either contains an observed rating (1-5) for that movie (row) by that user (column), or is blank (not zero) meaning you don't know. To quantify “big”, sticking with the round numbers, this matrix would have about 8.5 billion entries (number of users times number of movies). Note also that this means you are only given values for one in eighty five of the cells. The rest are all blank.

Netflix has then posed a “quiz” which consists of a bunch of question marks plopped into previously blank slots, and your job is to fill in best-guess ratings in their place. They have chosen mean squared error as the measure of accuracy, which means if you guess 1.5 and the actual rating was 2, you get docked for (2-1.5)ˆ2 points, or 0.25. (In fact, they specify root mean squared error, referred to as rmse, but since the two measures are monotonically related, one can safely use the simpler of the two and achieve the same result.)

What is a Feature?

A feature is a pattern, a generality, or a regularity. A feature allows us to reduce the amount of information in a representation of data; it gives us a label that stands for other information or data; it enables us to predict or reconstruct missing or unknown information or data. In short, discovering features in data is learning, having representations of them is knowing, and using them to predict missing or unknown data or to respond in some other useful way is intelligent inference.

Applying these principles to the preferred embodiment, imagine for a moment that we have the whole shebang—8.5 billion ratings, no empty cells, and a lot of weary users. Presumably there are some generalities to be found in there, something more concise and descriptive than 8.5 billion completely independent and unrelated ratings. For instance, any given movie can, to a rough degree of approximation, be described in terms of some basic features such as overall quality, whether it's an action movie or a comedy, what stars are in it, and so on. And every user's preferences can likewise be roughly described in terms of features like whether they tend to rate high or low, whether they prefer action movies or comedies, what stars they like, and so on. And if those basic assumptions are true, then a lot of the 8.5 billion ratings ought to be explainable by a lot less than 8.5 billion numbers, since, for instance, a single number specifying how much action a particular movie has may help explain why a few million action-buffs like that movie.

A property of machine learning is that this reasoning works in reverse too: If meaningful generalities (features) can help you represent your data with fewer numbers, then finding a way to represent your data in fewer numbers can often help you find meaningful generalities. Compression is akin to understanding.

Using SVD to Discover and Use Linear Features

In practice this means defining a model of how the data is put together from a smaller number of features, and then deriving a method of automatically inferring from the data what those features should actually be. In my inference engine, that model is called singular value decomposition, which is just a fancy way of saying that we'll assume that a user's rating of a movie is composed of a sum of his preferences about the various features of that movie in proportion both to the strength of his preferences and the prominence of those features.

For example, imagine that each movie is fully described for the purposes of ratings by only forty values saying how much that movie possesses each feature, and correspondingly each user is fully described for ratings purposes by forty values saying how much that user prefers each feature. To combine these all together into a rating for one movie, we just multiply the user's preference for each feature by the movie's possession of the same feature, and then add those forty leanings up into a final calculation of how much that user likes that movie. For example, an imaginary movie called Chase'em a Little might be (action=1.2, chickflick=−1, . . . ), and user Joe might be (action=3, chickflick=−1, . . . ), and when you combine the two you get Joe likes Chase'em a Little with 3*1.2+−1*−1+. . . =4.6+. . . Note here that Chase'em a Little is tagged as an anti-chickflick, and Joe likewise as someone with an aversion to chickflicks, so Chase'em a Little actively scores positive points with Joe for being decidedly un-chickflicky. As you can see, negative numbers for features are both useful and permitted. All told that model requires 40*(17,000+500,000) values, or about 20 million, which is 400 times less than the original 8.5 billion.

We can express the foregoing as a formula defining the matrix of the ratings by 500,000 users of 17,000 movies such that, for each combination of a user and a movie, the rating is the sum, for each feature, of the product of the user's preference for that feature and the movie's possession of that feature:
rating_matrix[user][movie]=sum, for feature from 1 to 40, user_value[feature][user]*movie_value[feature][movie]
In the above formula, rating_matrix is a matrix of approximated ratings by 17,000 users of 500,000 movies. Each cell in rating_matrix contains the approximated rating by one user of one movie. In the same formula, user_value is the matrix of the value of each feature with respect to each user, capturing the user's preference for that feature. Each cell in user_value contains one feature's value with respect to one user. Finally, in the same formula, movie_value is the matrix of the value of each feature with respect to each movie. Each cell in movie_value contains one feature's value with respect to one movie, capturing the movie's possession of that feature.

Thus, the original matrix has been decomposed into two very oblong matrices: the 17,000×40 movie feature matrix (movie_value), and the 500,000×40 user feature matrix (user_value). Multiplying the user feature matrix by the movie feature matrix performs the products and sums described above, resulting in our approximation to the 17,000×500,000 original rating matrix. Singular value decomposition is just a mathematical trick for finding those two smaller matrices that minimize the resulting approximation error—specifically the mean squared error.

So, in other words, if we take the rank-40 singular value decomposition (SVD) of the 8.5 billion cell matrix, we have the best (least error) approximation we can within the limits of our user-movie-rating model. Which means that the SVD has found our best 40 features for us.

The procedure in the preceding paragraphs can be generalized to other embodiments to represent any data that can be interpreted as a two dimensional data matrix. Thus, we could use my inference engine in other embodiments by generalizing the formula above to:

data_matrix[column][row] = sum (over feature) of

column_value[feature][column] *
row_value[feature][row];

In the above formula, data_matrix is our approximated data matrix. Each cell in data_matrix contains a value associated with the properties identified by its column and row. In the same formula, column_value is the matrix of the value of each feature with respect to each column, capturing some connection between the property identified by the column and the feature. Each cell in column_value contains one feature's value with respect to the property identified by the column. Finally, in the same formula, row_value is the matrix of the value of each feature with respect to each row. Each cell in row_value contains one feature's value with respect to the property identified by one row, capturing some connection between the property identified by the row and the feature.
Singular Value Decomposition Made Easy

Unfortunately, for the purposes of this embodiment, we don't have 8.5 billion entries, we have 100 million entries and 8.4 billion empty cells. In other words, we have a sparse matrix. There's another problem too, which is that computing the SVD of large matrices in the usual way is complicated, and takes a long time and a lot of resources. It is on these two problems that many of the previous methods of using SVD to predict data have come to grief.

However, there turns out to be a simple alternative approach which stems from abandoning the matrix foundations assumed by nearly all related prior art: just take the derivative of the approximation error and follow it. This method has many advantages, including the fact that it allows us to choose simply to ignore the unknown error on the 8.4 billion empty cells and likewise gives us a consistent way of handling multiple values belonging in the same cell.

If we write out the equations for the error (measured as squared difference) between the SVD-like model and the original data—just the given values, not the empty cells—we get:

total_error = sum, over known <user, movie, rating>, of

(rating − rating_matrix[user][movie])\hat{ }2;

If we then compute and follow the gradient of that total error with respect to the parameters we're trying to infer, we get the rather simple result which follows (expressed here in C code):

user_value[feature][user] += lrate * err *

movie_value[feature][movie];

movie_value[feature][movie] += lrate * err *

user_value[feature][user];

The above code is evaluated for each feature being trained, for each rating (with associated user and movie) in the training database. Lrate is the learning rate, which for purposes of the Netflix data was set to 0.001, but that can also be set to some other value or set of values that optimizes the predictions. Err is the residual error from the current prediction, that is to say the difference between the known rating and the current estimate, rating_matrix[user] [movie], as computed above.

So, in context, the code to use one known rating to train user_value and movie_value with respect to one feature might look like this in C:

real predict_rating(int movie, int user)
{

real estimate = 0.;
for (int feature=0; feature<num_features; feature++)

estimate += user_value[feature][user] *

movie_value[feature][movie];

return estimate;

}
void train(int user, int movie, real rating, int feature)
{

real lrate = 0.001;
real err = rating − predict_rating(movie, user);
user_value[feature][user] += err * lrate *

movie_value[feature][movie];

movie_value[feature][movie] += err * lrate *

user_value[feature][user];

}
Note that predict_rating uses user_value and movie_value to do its work, so there's a tight feedback loop in play.

Slightly uglier but more correct, unless you're using an atemporal programming language you will want to do this:

uv = user_value[feature][user];
user_value[feature][user] += err * lrate *

movie_value[feature][movie];

movie_value[feature][movie] += err * lrate * uv;

If you stick to just one feature at a time, the above train( ) method, when iterated over the many ratings in the training database, will find the most prominent feature remaining (the one that will most reduce the error that's left over after previously trained features have done their best). Thus, if you start with just one feature in your model, train it until it's as good as it's going to get, and then add a second feature and train it on what's left, and so on for N features in total, movie_value and user_value will come to represent the N most important features (in terms of their contribution to reducing the approximation error) in order of descending importance.

For efficiency's sake, the residual errors can be cached (all 100 million of them) so when you're training feature 72 you don't have to wait for predict_rating( ) to re-compute the contributions of the previous 71 features. For the preferred embodiment, you will need a computer with about 2 gigabytes of ram to do this.

The code given above for the preferred embodiment can be generalized to data matrices used for other embodiments by writing it as:

first_factor_matrix[feature][data_row] += lrate * err *

second_factor_matrix[data_column][feature];

second_factor_matrix[data_column][feature] += lrate * err *

first_factor_matrix[feature][data_row];

Here the second factor matrix (corresponding to the movie_value matrix in the preferred embodiment) has been transposed so that the approximated data matrix can be said to be a straight matrix product of the first and second factor matrices.
Initializing the Feature Vector Matrices

There remains the question of what to use for initial values in the feature vector matrices (user_value and movie_value) when you begin to train a new feature. Unlike backprop and many other gradient descent algorithms, my inference engine is not subject to local minima. This insensitivity to initial values, in the case where the method is run to convergence, is one of the advantages of the invention over other gradient methods. In the preferred embodiment, I initialize all the cells of both vectors (user_value[feature] and movie_value[feature]) to 0.1, but they can be set to other values as well. How these vectors are initialized actually does matter a bit later, to the extent that a particular feature is not run to completion, as is explained more fully below.

Getting a Head Start on the Predicted Ratings

Before even starting with the SVD, one can get a good head start on predicted ratings for the training data (the contents of the cells in rating_matrix that have known values) by noting the average rating for every movie, as well as the average offset between a user's rating and the movie's average rating, for every user. Thus, the prediction method for this baseline model is:

real predict_rating_baseline(int movie, int user)
{

return average_rating[movie] + average_offset[user];

}

This in turn can be used as the return value of predict_rating before the first SVD feature even starts training, in effect setting the SVD upon learning only the remaining residual error left over after this baseline estimate. An easy way to do this is simply to replace, in the predict_rating( ) method:
real estimate=0.;
   with:
real estimate =predict_rating_baseline(movie, user);
   In fact any prediction algorithm can be used as a baseline this way and then potentially improved upon by using my invention to further reduce the remaining error.
   Correcting for Incomplete Training Data

Because the training data is only a subset of the total possible data, using the average of the ratings in the training data as the average rating for the movie can be suboptimal, especially where there are few ratings for a movie. To use an extreme example, what if there's a movie which only appears in the training set once, say with a rating of 1. Does it have an average rating of 1 when calculated on the whole data set, including unknown, hypothetical, and future data? Probably not.

In fact, you can view that single observation as a draw from a true probability distribution whose average you want, and you can view that true average itself as having been drawn from a probability distribution of averages—essentially the histogram of average movie ratings. If we assume both distributions are Gaussian, the actual best-guess mean should be a linear blend between the observed mean and the a priori mean, with a blending ratio equal to the ratio of variances. That is, if Ra and Va are the mean and variance (squared standard deviation) of all of the movies' average ratings (which defines your prior expectation for a new movie's average rating before you've observed any actual ratings) and Vb is the average variance of individual movie ratings (which tells you how indicative each new observation is of the true mean (for example, if the average variance is low, then ratings tend to be near the movie's true mean, whereas if the average variance is high, then ratings tend to be more random and less indicative), then:

naive_mean = sum(observed_ratings)/count(observed_ratings);
K = Vb/Va;
better_mean = [global_average*K + sum(observed_ratings)] /

[K + count(observed_ratings)];

For the preferred embodiment, I used K=25.

The same principle and method is applied to computing the user offsets. The point here is simply that any time you're averaging a small number of examples, the true average is most likely nearer the apriori average than the sparsely observed average. Note if the number of observed ratings for a particular movie is zero, better_mean (best guess) above defaults to the global average movie rating as one would expect.

Avoiding Overfitting with a Regularization Term

Even though we've managed to decompose rating_matrix, with its 8.5 billion free parameters, into two much smaller matrices, twenty million free parameters is still rather a lot for a training set with only 100 million examples. While it seems like a neat idea to just ignore all those blank spaces in the implicit ratings matrix, the truth is we have some expectations about what's in them, and we can use that to our advantage.

As described up to this point, the incremental SVD algorithm employed in my inference engine can be suboptimal for sparsely observed movies or users. To give an example, imagine you have a user named Joe who has only rated one movie, which we'll call Not Much Action. Let's say Joe has given Not Much Action a rating of 2 while the average rating is 4.5, and further that his offset is only −1, so we would, prior to even employing the SVD, expect him to rate this movie 3.5. So the error given to the SVD is −1.5 (the true rating is 1.5 less than we expect). Now imagine that the current movie-side feature (movie_value[feature]) based on broader context, is training up to measure the amount of Action, and let's say that the current movie_value[feature][movie] is a paltry 0.01 for movie Not Much Action. The SVD, recall, is trying to optimize our predictions, which it can do by eventually setting our user's preference for Action to a huge −150.0. That is, the algorithm naively looks at the one and only example it has of this user's preferences, in the context of the one and only feature it knows about so far (Action), and determines that Joe so hates action movies that even the tiny bit of action in Not Much Action makes him hate it. This is not a problem for users for whom we have lots of observations because those random apparent correlations average out and the true trends dominate.

So, once again, we need to account for priors. As with the average movie ratings, it would be nice to be able to blend our sparse observations in with some sort of prior, but it's a little less clear how to do that with this incremental algorithm. But if you look at where the incremental algorithm theoretically converges, dropping the feature index momentarily for clarity, you get something like:

user_value[user] = [sum residual[user,movie] *

movie_value[movie]] / [sum (movie_value[movie]\hat{ }2)];

Since the residual here is taken after the baseline rating prediction has been removed, the numerator in the formula above will fall in a roughly zero-mean Gaussian distribution when charted over all users, which leads to:

user_value[user] =

[sum residual[user,movie] * movie_value[movie]] /
[sum (movie_value[movie]\hat{ }2 + k1)];

And finally back to an improved version of our two key training lines:

user_value[feature][user] += lrate *

(err * movie_value[feature][movie] −
k1 * user_value[feature][user]);

movie_value[feature][movie] += lrate *

(err * user_value[feature][user] −
k2 * movie_value[feature][movie]);

Put another way, instead of following the gradient of just our total error, we are now following the gradient of a more general cost function which includes, in addition to the error, a regularization term which tries to penalize the complexity or specificity of the model. In this case, for any given feature (again dropping the feature index for clarity):

cost_function = total_error + reg_term;
reg_term = sum, over known <user, movie, rating>, of

k1 * user_value[user]\hat{ }2 + k2 * movie_value[movie]\hat{ }2;

Here k1 and k2 are tunable regularization coefficients which determine how much to penalize the magnitudes of the feature values. Note that in this particular formulation the feature values are penalized in proportion to how often they occur in the data set. Other sum extents are possible, as are other regularization terms entirely, depending on the prior distributions of the data set in question or on other measures of model complexity or specificity, but the above version worked best, of all those tried, in the preferred embodiment.

The regularization coefficients k1 and k2 in the formula above are set to one or more selected values based on empirical testing, depending on the number of features that are desired, and in this embodiment, where I train over 100 features, both are set to about 0.015 with some hand-tailored variation for the first few features.

Accounting for Nonlinearities

Linear models are pretty limiting. To overcome some of these, my inference engine includes some non-linear outputs, such as clipping and curve fitting. This is one of the reasons why the invention is said to use an incremental method of “generalized” singular value decomposition. When the parameters that modify the results to account for nonlinearities are omitted or set to values that cause them to have no effect on the outcome, the data exactly fill the implicit data matrix, and the method is run to convergence, the result is mathematically equivalent to performing a standard singular value decomposition of the implicit data matrix.

Clipping

To account for some nonlinearities, where in the earlier case we predicted any given rating with:

rating_matrix[user][movie] = sum, for feature from 1 to N,

user_value[feature][user] *
movie_value[feature][movie];

my inference engine generalizes this to (expressed here in pseudocode):

estimate = predict_rating_baseline(movie, user);
for each feature from 1 to N:

estimate = G(estimate + F(

user_value[feature][user] *
movie_value[feature][movie]));

rating_matrix[user][movie] = H(estimate);

Note that if F, G, and H are all the identity function (i.e., e.g., F(x)=x), and if the initial baseline estimate is trivially set to zero, then the generalized form reduces to the simpler form. Certain choices for these functions proved especially useful and are used in this embodiment, although many others are possible, contemplated, and included within alternative embodiments of the invention. One is to have G simply clip the prediction to the range 1-5 after each component is added in. That is, each feature is limited to only swaying the rating within the valid range, and any excess beyond that is lost rather than carried over. So, if the first feature suggests +10 on a scale of 1-5, and the second feature suggests −1, then instead of getting a 5 for the final clipped score, it gets a 4 because the score was clipped after each stage. The intuitive rationale here is that we tend to reserve the top of our scale for the perfect movie, and the bottom for one with no redeeming qualities whatsoever, and so there's a sort of measuring back from the edges that we do with each aspect independently. More pragmatically, since the target range has a known limit, clipping is guaranteed to improve our performance, and having trained a stage with clipping on we should use it with clipping on.
Curve Fitting

A useful choice for F, among many others contemplated for alternative embodiments of the invention, is to introduce some functional non-linearity such as a sigmoid. In other words, F(x)=sigmoid(x).

Even if F, G, and H are fixed (non-adaptive), these require modifying the learning rule slightly to include their slopes, but that's straightforward (and falls naturally out of the gradient computation with those functions included). However, for functions which operate mostly within a substantially unit-gain linear region (which include all examples mentioned here), satisfactory results can be obtained without modifying the learning rule at all (other than as happens inherently via the impact of these functions on the predict_rating method).

The next question is how to adapt these functions to the data. I tried a couple of options for F and H, including an adaptive sigmoid, but the most general, the one that worked the best, and the one that was used in this embodiment was simply to fit a piecewise linear approximation to the true output/output curve. That is, if you plot the true output of a given stage (e.g., the input to F above) against the average target output (e.g., the average of the corresponding residual which F is ultimately trying to follow), the linear model assumes this is a nice 45 degree line. But in truth, for the first feature for instance, you end up with a kink around the origin such that the impact of negative values is greater than the impact of positive ones. That is, for two groups of users with opposite preferences, each side tends to penalize more strongly than the other side rewards for the same quality. Or put another way, below-average quality (subjective) hurts more than above-average quality helps. There is also a bit of a sigmoid to the natural data beyond just what is accounted for by the clipping.

The linear model can't account for these, so it just finds a middle compromise; but even at this compromise, the inherent non-linearity shows through in an actual-output vs. average-target-output plot, and if F is then simply set to fit this, the model can further adapt with this new performance edge, which leads to potentially more beneficial non-linearity and so on. This curve fitting introduces new free parameters and again encourages overfitting, especially for the later features, which tend to represent fairly small groups. We found it beneficial to use this non-linearity only for the first twenty or so features and to disable it after that. A similar approach can be gainfully used to optimize the final function H.

The code given above for the preferred embodiment can be generalized to data matrices used for other embodiments by writing it as:

estimate = baseline(data_column, data_row);
for each feature from 1 to N:

estimate = G(estimate + F(

second_factor_matrix[data_column][feature] *
first_factor_matrix[feature][data_row]));

approximated_matrix[data_column][data_row] = H(estimate);

Here the second factor matrix (corresponding to the movie_value matrix in the preferred embodiment) has been transposed for consistency with the previous generalized form.
Avoiding Overfitting

Despite the regularization term that is implemented as coefficients k1 and k2 in the final incremental law above, over-fitting remains a problem. Most finite data sets, even those generally considered large by today's standards, are still small enough to necessitate revisiting the same training data more than once. Each such pass through the data set is traditionally called one epoch, and plotting the progress over such epochs will generally reveal that the graph of the error measured against a held-out sample of data with known ratings that are not included in the training set eventually turns upward and starts getting worse (even though the training error is still inching down). That is, the model has over-fit to the exact training data which is being revisited over and over and is no longer generalizing well to data outside of that set. I found that simply choosing a fixed number of training epochs appropriate to the learning rate and regularization constant resulted in the best overall performance. In the preferred embodiment, for a learning rate of about 0.001 and a regularization constant of about 0.0150 it was about 120 epochs per feature, at which point the feature was considered done and we moved on to the next before the model started overfitting.

Note that now it does matter how you initialize the vectors: Since we're stopping the path before it gets to the (common) end, where we started will affect where we are at that point.

Training All the Features at Once

Finally, while thus far I have described computing the features one at a time in succession, in order of decreasing relevance starting with the most prominent feature, a somewhat better end result can be obtained by training all of the features simultaneously. For the simple linear case, amounting to standard singular value decomposition, there would be nothing to be gained here since the features become orthogonal to each other even when trained separately, and thus have no impact on each other's gradients. However, both the regularization term and the non-linearities (including clipping) take us away from full orthogonality and thus create room for the earlier features to adjust in light of the contribution of later ones. While in principle the model could be trained up from scratch all features at the same time, I found it most efficient to train them in succession first, which achieves most of the progress via a computationally simpler task, and then to switch to training all of the features simultaneously to garner that last bit of optimality.

The end result of the invention is exactly the equivalent of a singular value decomposition in the case where the training set perfectly fills the matrix to be decomposed, the process is run to convergence, and there are no modifications to the basic method to account for nonlinearities. Traditionally, standard singular value decomposition results are expressed as two orthonormal matrices and one diagonal scaling matrix, whereas here the scaling matrix gets arbitrarily rolled in to the two side matrices, but this is merely a difference of representation and the traditional form could be trivially extracted if needed.

Conclusion

Therefore the reader will see that, according to the invention, I have provided a method that makes useful predictions concerning any category of phenomena where there are two classes of objects (or the same class twice) for which there is a particular value implicitly associated with each pairing of such objects.

While the above description contains many specificities, these should not be construed as limitations on the scope of the invention, but as exemplifications of the presently preferred embodiments thereof. Many other ramifications and variations are possible within the teachings of the invention, including but not limited to the objects and and advantages described above.

Thus, the scope of the invention should be determined by the appended claims and their legal equivalents, and not by the examples given.

I claim:

1. A method of incrementally approximating a generalized singular value decomposition of a data matrix comprising finding the gradient of a cost function incorporating the approximation error and following it.

2. The method of claim 1 wherein said data matrix is approximated as the product of two factor matrices, such that said finding the gradient of a cost function incorporating the approximation error and following it comprises iterating the steps of
2.1. computing said gradient of said cost function with respect to one or more factor values in said factor matrices, and
2.2. updating said factor values in the direction of said gradient.

3. The method of claim 2 wherein at any one time said factor values comprise one column from the first factor matrix of said product and the corresponding row from the second factor matrix of said product.

4. The method of claim 3 wherein said column and row are chosen in consecutive order starting from the first column and row and where said iterating is continued on each such column and row until a convergence criterion is met.

5. The method of claim 2 wherein said cost function incorporates the mean squared difference between the data values of said data matrix and the corresponding approximated values of said approximated matrix, such that the steps of computing said gradient and updating said factor values include for each said data value with corresponding data column and data row and for each corresponding pair of said factor values the method expressed by the C programming language instructions:
first_factor_matrix[feature][data_row] += lrate *
err * second_factor_matrix[data_column][feature];
second_factor_matrix[data_column][feature] += lrate *
err * first_factor_matrix[feature][data_row];
where said 1rate is the learning rate, said feature is the column and corresponding row of said corresponding pair of said factor values, said err is said data value of said data matrix at said data column, which is denominated above as data_column, and said data row, which is denominated above as data_row, minus said approximated value of said approximated matrix at the same column and row.

6. The method of claim 5 wherein said cost function incorporates a regularization term such that the steps of computing said gradient and updating said factor values include for each said data value with corresponding data column and data row the method expressed by the C programming language instructions:
first_factor_matrix[feature][data_row] *=
1.0 − lrate * k1;
second_factor_matrix[data_column][feature] *=
1.0 − lrate * k2;
where said k1 and said k2 are non-negative regularization coefficients less than one.

7. The method of claim 1 wherein said data matrix is approximated as a modified product of two factor matrices as expressed by the following pseudocode:
estimate = baseline(data_column, data_row);
for each feature from 1 to N:
estimate = G(estimate + F(
second_factor_matrix[data_column][feature] *
first_factor_matrix[feature][data_row]));
approximated_matrix[data_column][data_row] = H(estimate);
where said G, said F, and said H are functions to account for nonlinearities, said N is the number of features, and said baseline is a predetermined function.

8. The method of claim 1 wherein said method of incrementally approximating a generalized singular value decomposition of a data matrix is used to predict the value of a cell of said data matrix.

9. The method of claim 7 wherein said function G is used to limit said predicted values of said data matrix to expected values.

10. The method of claim 7 wherein at least one of said functions F, G, and H is to some extent determined empirically to fit the observed curve of average desired output versus estimated output.

11. A method of predicting a target value corresponding to a pair of query objects comprising substantially the steps of
11.1. setting a current estimate to an initial value,
11.2. for each feature of a set of one or more features,
11.2.1. multiplying a first feature value corresponding to said feature and the first query object by a second feature value corresponding to said feature and the second query object,
11.2.2. applying a first function corresponding to said feature to the product resulting from step 11.2.1,
11.2.3. applying a second function corresponding to said feature to the sum of the output of said first function from step 11.2.2 and said current estimate, and
11.2.4. updating said current estimate to equal the output of said second function from step 11.2.3, and
11.3. applying a final function to final said current estimate resulting from step 11.2, such that said predicted target value corresponding to the pair of query objects is the output of said final function.

12. The method of claim 11 wherein one or more of the feature values described in step 11.2.1 is automatically determined by a method comprising substantially the steps of
12.1. setting each said feature value according to a corresponding initial feature value estimate,
12.2. for each datum of a set of one or more known data, each comprising a pair of query objects and a single corresponding known target value, computing the gradient with respect to said feature values of a cost function incorporating an error function of said datum's known target value and the corresponding predicted target value determined by the method of claim 11 from said datum's corresponding query objects,
12.3. summing said gradient from 12.2 over said set of one or more known data to create a composite gradient,
12.4. scaling said composite gradient of 12.3 by a learning rate, and
12.5. subtracting the scaled composite gradient described in 12.4 from said feature values to produce the final automatically determined feature values.

13. The method of claim 12 wherein one or more of said initial feature value estimates are set to values determined at least in part by said final automatically determined feature values produced by a prior application of the method of claim 12.

14. The method of claim 12 wherein said cost function is the square of the difference between said known target value and said corresponding predicted target value, each said first function described in step 11.2.2 is operating primarily in a substantially unit-gain linear region, each said second function described in step 11.2.3 is operating primarily in a substantially unit-gain linear region, and said final function described in step 11.3 is operating primarily in a substantially unit-gain linear region, such that said feature values can be computed from said initial feature value estimates with the following C programming language instructions or their substantial functional equivalent:
first_feature_value[first_obj][feature] =
first_feature_value_estimate[first_obj][feature] +
lrate * residual *
second_feature_value_estimate[second_obj][feature];
second_feature_value[second_obj][feature] =
second_feature_value_estimate[second_obj][feature] +
lrate * residual *
first_feature_value_estimate[first_obj][feature];
where said 1rate is said learning rate of step 12.4, and said residual is said known target value minus said predicted target value.

15. The method of claim 12 wherein said cost function is the square of the difference between said known target value and said corresponding predicted target value, plus a regularization coefficient times the sum of the squares of said corresponding initial feature value estimates, each said first function described in step 11.2.2 is operating primarily in a substantially unit-gain linear region, each said second function described in step 11.2.3 is operating primarily in a substantially unit-gain linear region, and said final function described in step 11.3 is operating primarily in a substantially unit-gain linear region, such that said feature values can be computed from said initial feature value estimates with the following C programming language instructions or their substantial functional equivalent:
first_feature_value[first_obj][feature] =
first_feature_value_estimate[first_obj][feature] *
(1.0 − lrate * k1[feature]) + lrate * residual *
second_feature_value_estimate[second_obj][feature];
second_feature_value[second_obj][feature] =
second_feature_value_estimate[second_obj][feature] *
(1.0 − lrate * k2[feature]) + lrate * residual *
first_feature_value_estimate[first_obj][feature];
where said 1rate is said learning rate of step 12.4, said residual is said known target value minus said predicted target value, and said k1 and said k2 are said regularization coefficients for each said feature.

16. The method of claim 12 wherein said known target value is the remaining difference between a known true target value and a corresponding initial estimate.

17. The method of claim 14 wherein
17.1. each said initial feature value estimate is set to be equivalent to said final automatically determined feature value resulting from a prior iteration of claim 14, and
17.2. said method of claim 14 is applied iteratively over samples drawn from a data matrix using respectively the row and column positions and corresponding cell value of each said sample as said pair of query objects and said corresponding known target value in step 12.2.
whereby a partial singular value decomposition of said data matrix is accomplished that can be used, among other things, to predict the missing values of said data matrix.
